(19) United States
(12) Patent Application Publication
(10) Pub. No.: US 2010/0188186 A1
(43) Pub. Date: Jul. 29, 2010

(54) SOFT MAGNETIC AMORPHOUS ALLOY

(75) Inventors: Akiri Urata, Miyagi (JP); Hiroyuki Matsumoto, Miyagi (JP); Akihiro Makino, Miyagi (JP)

Correspondence Address: FRISHAUF, HOLTZ, GOODMAN & CHICK, PC, 220 Fifth Avenue, 16TH Floor, NEW YORK, NY, 10001-7708, US

(73) Assignees: NEC Tokin Corporation, Sendai-shi, Miyagi (JP); Tohoku University, Sendai-shi, Miyagi (JP)

(21) Appl. No.: 12/678,938

(22) PCT Filed: Sep. 16, 2008
(86) PCT No.: PCT/JP2008/002545

§ 371 Date: Mar. 18, 2010

(30) Foreign Application Priority Data
Sep. 18, 2007 (JP) 2007-240540

(51) Int. Cl. H01F 27/24; H01F 1/153

(52) U.S. Cl. 336/233; 148/304

(57) ABSTRACT

A soft magnetic amorphous alloy represented by the following composition formula: {Feₐ(SiₓB_{y}P_{z})1-a}_{100-b}L_{b}. In the composition formula, L represents one or more elements selected from Al, Cr, Zr, Nb, No, Hf, Ta and W, and a, b, x, y, and z meets the conditions of: 0.7≦a≦0.82; 0≦b≦5 atomic %; 0.05≦x≦0.6; 0.1≦y≦0.85; 0.05≦z≦0.7; and x+y+z=1.

### TECHNICAL FIELD

This invention relates to a soft magnetic amorphous alloy, and powder, a dust core, an inductor, a ribbon, a piece, and a bulk member using the same.

### BACKGROUND ART

Developments of a soft magnetic amorphous alloy has been started from Fe—P—C which, at the beginning, was amorphous alloy having no supercooled liquid region. Since then, a low loss material, for example Fe—Si—B, or a high saturation magnetic flux density composition, for example Fe—B—C, has been developed. Since the soft magnetic amorphous alloy is a low loss material, it is anticipated to be a magnetic material with high efficiency to be used in, for example, transformers. However, amorphous alloy is not in a widespread use because it is expensive in cost and has a low saturation magnetic flux density (Bs) as compared to the known material such as silicon steel plate. Moreover, a method of manufacturing amorphous alloy requires cooling temperature of 10⁵° C./second or higher so that, in the present circumstances, ribbons having only 20 μm may be produced. Therefore, in order to use the ribbons as productive components, the ribbons should be multilayered or made as wound magnetic cores. For this reason, the use of the amorphous alloy is extremely limited.

Since the late 1980s, an alloy based material which is so called metallic glass has been discovered. Unlike the conventional amorphous alloy which has no supercooled liquid region, glass transition is observed within the metallic glass at a portion where crystallization temperature is relatively low. The supercooled liquid regions is considered to be contributing to a stable glass construction. For this reason, the metallic glass having the supercooled liquid region has an efficient capability of forming an amorphous phase as compared to the conventional materials. For example, by Ln—Al—Fe based, Zr—Al—Ni based, or Pd—Cu—Ni—P based metallic glass alloy, it is possible to produce a bulk member having a thickness from several millimeters to several centimeters.

Fe-based metallic glass has been discovered since the middle of 1990s. Patent Documents 1 to 4 and Non-Patent Documents 1 and 2 disclose metallic glass such as, for example, Fe—(Al,Ga)—(P, C, B, Si) based alloy. However, the alloys disclosed in the above-mentioned documents contain Ga, which improves the amorphous characteristic but is extremely expensive. For this reason, it is difficult to industrialize these alloys.

Patent Document 5 and Non-Patent Document 3 disclose Fe—Si—B—Nb based alloy. The alloy having a thickness of 1.5 mm at maximum can be manufactured from these alloys, In addition, according to Non-Patent Document 4, when Nb is added to the composition of alloy, a saturation magnetic flux density rapidly decreases and the saturation magnetic flux density becomes about 1.2 T. Moreover, alloy containing Co or Ni has an efficient capability of forming an amorphous phase but the saturation magnetic flux density is reduced and the cost of raw material increases.

Patent Documents 6 and 7 and Non-Patent Document 5 disclose Fe—B—(Zr, Nb) based amorphous alloy. Non-Patent Document 6 discloses Co—Fe—Ta—B based amorphous alloy. The disclosed amorphous alloys have a small saturation magnetic flux density so that they are poor in the general versatility.

Hereinafter, alloys having no supercooled liquid region and alloys having the supercooled liquid region (metallic glass) are both referred to as amorphous alloys.

Patent Document 1: JP-A H09-320827

Patent Document 2: JP-A H11-071647

Patent Document 3: JP-A 2001-152301

Patent Document 4: JP-A 2001-316782

Patent Document 5: JP-A 2003-253408

Patent Document 6: JP-A 2000-204452

Patent Document 7: JP-A H11-131199

Non-Patent Document 1: Mater. Trans. JIM, 36 (1995), 1180

Non-Patent Document 2: Mater. Trans. 43 (2002) 1235

Non-Patent Document 3: Mater. Trans. 43 (2002) 769

Non-Patent Document 4: Intermetallics. 15 (2007), 9

Non-Patent Document 5: Mater. Trans. JIM, 38 (1997), 359

Non-Patent Document 6: Acta Materialia. 52 (2004), 1631

Non-Patent Document 7: Appl. Phys. Lett., 85, 21 (2004)

Non-Patent Document 8: Intermetallics, 14 (2006), 936

### DISCLOSURE OF INVENTION

### Problem(s) to be Solved by the Invention

It is therefore an object of the present invention to provide a soft magnetic amorphous alloy containing Fe as a principal component, having an excellent capability of forming an amorphous alloy, an excellent soft magnetic property and a high corrosion resistance, at low cost.

Another object of the present invention is to provide powder, a dust core, an inductor, a ribbon, a piece, and a bulk member using the above-mentioned soft magnetic amorphous alloy.

### Means to Solve the Problem

The inventors have diligently studied a variety of alloy compositions to solve the aforementioned problems and have discovered that, by adding at least one rlrmrny selected from Al, Cr, Zr, Nb, Mo, Hf, Ta, and W to Fe—Si—B—P based soft magnetic amorphous alloy system and limiting the element os the composition, a capability of forming an amorphous phase is greatly improved and a clear supercooled liquid region is appeared.

According to the present invention, the soft magnetic amorphous alloy represented by a composition formula {Feₐ(SiₓB_{y}P_{z})₁₋ₐ}_{100-b}L_{b} is obtained. L is one of more elements selected from Al, Cr, Zr, Nb, Mo, Hf, Ta and W. The conditions: 0.7≦a≦0.82; 0≦b≦5 atomic %; 0.05≦x≦0.6; 0.1≦y≦0.85; 0.05≦z≦0.7; and x+y+Z=1 are met.

### EFFECT(S) OF THE INVENTION

According to the present invention, there can be provided a soft magnetic amorphous alloy efficient in capability of forming an amorphous alloy and a soft magnetic property, having a high saturation magnetic flux density and a high corrosion resistance, and can be manufactured at low cost. Moreover, a dust core, an inductor, a ribbon, a piece, and a bulk member using the soft magnetic amorphous alloy of the present invention can be provided. Furthermore, by using the above-mentioned materials, a magnetic material such as, for example, an inductance element, a magnetic head and a magnetic recording medium as well as a magnetic core of the inductor can be provided.

### BRIEF DESCRIPTION OF DRAWINGS

FIG. 1 A view showing an X-ray diffraction profile of a molded rod-like member which is manufactured by a metal mold casting method and which has a diameter of 3 mm. Herein, an amorphous alloy composition of a sample contains {Fe_{0.75}(Si_{0.4}B_{0.4}P_{0.2})}₉₉Nb₁ and {Fe_{0.76}(Si_{0.2}B_{0.7}P_{0.1})_{0.24}}₉₆Nb₄.

FIG. 2 A view showing a DSC profile of a ribbon manufactured by a single roll method. Herein, an amorphous alloy composition of a sample contains {Fe_{0.75}(Si_{0.4}B_{0.4}P_{0.2})}₉₉Nb₁ and {Fe_{0.76}(Si_{0.2}B_{0.7}P_{0.1})_{0.24}}₉₆Nb₄.

FIG. 3 A schematic view showing a device for use in manufacturing a sample of mold rod-like member by a metal mold casting method.

FIG. 4 A view showing Hc of a three alloy composition diagram of {Fe_{0.76}(SiₓB_{y}P_{z})_{0.24}}₉₈ Nb₂.

FIG. 5(a) is a perspective view showing an inductor according to the present embodiment, and (b) is a side view of (a).

FIG. 6 A graph showing an implementation efficiency of the inductor of the present embodiment.

FIG. 7 A schematic view showing a device for manufacturing a sample of a molded disk-like plate by a metal mold casting method.

### DESCRIPTION OF REFERENCE NUMERALS

1 Master alloy
2 Small hole
3 Quartz nozzle
4 Rod-like mold
5 Copper mold
6 High frequency generation coil
7 Dust core
8 Coil
9 Surface implementation terminal
10 Inductor
11 Master alloy
12 Small hole
13 Quartz nozzle
14 Disk-like shaped mold
15 Copper mold
16 High frequency generation coil

### BEST MODE FOR CARRYING OUT THE INVENTION

A soft magnetic amorphous alloy according to the present invention comprises a specific composition {Feₐ(SiₓB_{y}P_{z})₁₋ₐ}_{100-b}L_{b}. L is one or more elements selected from Al, Cr, Zr, Nb, Mo, Hf, Ta and W. a, b, x, y, and z meet the conditions: 0.7≦a≦0.82; 0≦b≦5 atomic %; 0.05≦x≦0.6; 0.1≦y≦0.85; 0.05≦z≦0.7; and x+y+z=1. In the soft magnetic amorphous alloy of the present invention, each component may contain unavoidable impurities.

Fe element is an element to provide magnetism in the above-mentioned specific composition. If the percentage of Fe element is lower than 0.7, then reduction of a capability of forming an amorphous phase and a saturation magnetic flux density is caused. If the percentage of Fe element is higher than 0.82, a supercooled liquid region is disappeared and reduction of the capability of forming an amorphous alloy is caused. Therefore, it is preferable to maintain the percentage of Fe element in a range from 0.7 to 0.82. Since a principal component of the alloy composition is Fe, which is a low cost element, it is possible to manufacture the amorphous alloy having the high saturation magnetic flux density at a low cost.

A part of Fe element may be replaced by one or more kinds of element selected from Co element or Ni element. If the percentage of Co element or Ni element is higher than 50 atomic %, it is difficult to be industrialized with regard to cost, and reduction of the saturation magnetic flux density is caused. Accordingly, it is preferable to maintain the percentage of Co element or Ni element in Fe element to less than 50%.

In the above-mentioned specific composition, Si element is an essential element for the soft magnetic amorphous alloy according to the present invention. If the percentage of Si element is lower than 0.05 or higher than 0.6, a supercooled liquid region is disappeared and reduction of a capability of forming an amorphous phase is caused. Therefore, it is preferable to maintain the percentage of Si in a range from 0.05 to 0.6.

In the above-mentioned specific composition, B element is an essential element for the soft magnetic amorphous alloy according to the present invention. If the percentage of B element is lower than 0.1 or higher than 0.85, a supercooled liquid region is disappeared and reduction of a capability of forming an amorphous phase is caused. Therefore, it is preferable to maintain the percentage of B element in a range from 0.1 to 0.85.

In the above-mentioned specific composition, P element is an essential element for the soft magnetic amorphous alloy according to the present invention. If the percentage of P element is lower than 0.05, a supercooled liquid region is disappeared and reduction of a capability of forming an amorphous phase is caused. If the percentage of P element is 0.7 or higher, a capability of forming an amorphous phase and the saturation magnetic flux density are reduced. Therefore, it is preferable to maintain the percentage of P element in a range from 0.05 to 0.7.

In the above-mentioned specific composition, L element is an element for improving a capability of forming an amorphous phase of Fe—Si—B—P alloy. If the percentage of L element is 5 atomic % or higher, the saturation magnetic flux density is reduced and thereby the soft magnetic property is reduced. Therefore, it is preferable to maintain the percentage of L element at 5 atomic % or less.

In the above-mentioned specific composition, L element also is an element which serves to improve a corrosion resistance. If the percentage of L element is smaller than 0.5 atomic %, discoloration of powder was observed after a water atomization, which is not preferable in appearance. If the percentage is higher than 5 atomic %, reduction of the saturation magnetic flux density is caused. Therefore, it is preferable to maintain the percentage of L element in a range from 0.5 atomic % to 5 atomic %. The improvement of the corrosion resistance was observed as a result of the environmental test of a dust core or an inductor.

In L element, Cr element is especially effective in improving the corrosion resistance. If the percentage of Cr element is smaller than 0.3 atomic %, discoloration of powder was observed after a water atomization, which is not preferable in the appearance. Therefore, it is preferable to maintain the percentage of Cr element in L element at 0.3 atomic % or higher. The improvement of the corrosion resistance was observed as a result of the environmental test of a dust core or an inductor.

L element is at least one kind of element selected from Al, Cr, Nb and Mo. Cr element may be included. If the percentage of L element is smaller than 1 atomic %, a noticeable improvement of the corrosion resistance is not observed as a result of the environmental test of a dust core or an inductor. If the percentage of L element is higher than 5 atomic %, the saturation magnetic flux density is reduced. Moreover, if the percentage of Cr element included in L element is smaller than 0.5 atomic %, a noticeable improvement of the corrosion resistance is not observed as a result of the environmental test of a dust core or an inductor. Accordingly, it is preferable to maintain the percentage of L element selected from Al, Cr, Nb, and Mo in a range from 1 atomic % to 5 atomic %, and the percentage of Cr element at 0.5 atomic % or higher in the case that requires the high corrosion resistance.

In the above-mentioned specific composition, amorphous alloy having a higher corrosion resistance may be obtained by adding a compound of L element and P element. In the above-mentioned specific composition, if the ratio U/b of a content U (=z(1-a)(100-b):atomic %) of P element and a content b of L element is smaller than 0.45, reduction of a capability of forming an amorphous phase and the saturation magnetic flux density is caused. If U/b is higher than 30, reduction of the capability of forming an amorphous phase, Hc, and the corrosion resistance is caused. Therefore, it is preferable to maintain U/b in a range from 0.45 to 30.

In L element, Cr element and Nb element are elements which serve to obtain an efficient corrosion resistance. Cr element especially is an element that only a small additive amount thereof is effective in improving the corrosion resistance and at the same time preventing reduction of the saturation magnetic flux density of alloy. It is preferable to maintain a ratio U/b_{cr} of a content b_{cr} of Cr element and a content U of P element in a range from 0.9 to 30. Moreover, a ratio U/b_{Nb} of content b_{Nb} of Nb element and a content U of P element is preferably in a range from 0.45 and 24.

The soft magnetic amorphous alloy according to the present embodiment has a saturation magnetic flux density of 1.2 T or higher. Generally, the improvement of the saturation magnetic flux density is useful in realizing a large current and miniaturization of a size of a part. In order to improve the saturation magnetic flux density, an amount of Fe content should be increased. In order to obtain the efficient capability of forming an amorphous phase and the high corrosion resistance, elements other than Fe (for example, Si, B, and P) should be added. However, Fe content in the alloy is reduced by adding the elements other than Fe. In addition, Fe content is further reduced as Cr element or the like is added for the purpose of further improving the corrosion resistance, whereby the saturation magnetic flux density will not exceed 1.2 T. Even crystal alloy such as permalloy and Sendust (registered trademark), which exhibit a small degree of magnetostriction and magnetic crystalline anisotropy, may not achieve the saturation magnetic flux density of over 1.2 T. In order to improve the property significantly as compared to the conventional amorphous alloy, it is preferable to achieve the saturation magnetic flux density at 1.2 T.

A supercooled liquid region of the soft magnetic amorphous alloy according to the present invention is in a range from 20° C. to 80° C. When a glass transition temperature is defined as Tg and a temperature at which crystallization starts is defined as Tx, a supercooled liquid region ΔTx is represented by ΔTx=Tx−Tg. Generally, when the soft magnetic amorphous alloy is heated in an inactive atmosphere of Ar or the like, a glass transition is generated. As the temperature raises higher, crystallization is generated. The supercooled liquid region correlates with a stabilization of an amorphous structure. It is well known that the capability of forming the amorphous phase becomes higher as the supercooled liquid region becomes wider and broader. If ΔTx is lower than 20° C., the capability of forming an amorphous phase will not improve drastically. Therefore, it is preferable that the condition is ΔTx≧20° C.

The soft magnetic amorphous alloy according to the present invention has a high capability of forming an amorphous phase and has a uniform amorphous structure. Therefore, powder having an amorphous single phase can be obtained even when a water atomization method which has a relatively low cooling rate is used. However, crystals are deposited when the average grain diameter of powder exceeds 150 μm. Therefore, it is preferable to set the average grain diameter of amorphous powder in a range from 1 μm to 150 μm. Since the soft magnetic amorphous alloy has a melting point relatively lower than that of the conventional amorphous alloy, viscosity of a molten alloy is reduced and therefore it may be easier to manufacture amorphous powder which is fine and spherical in shape. Generally, powder may be manufactured by a water atomization method or a gas atomization method. However, the present invention is not limited to those methods.

A dust core of the present embodiment is obtained by forming a mixture containing amorphous powder and a binder. Amorphous powder contained in the dust core of the present embodiment has a good soft magnetic property. As compared to the conventional various dust cores using powder such as metal powder, Fe—Si powder, Fe—Si—Cr powder and Sendust powder, the dust core according to the present embodiment may noticeably reduce the loss. Moreover, the above-mentioned soft magnetic amorphous alloy has a high specific electrical resistance as compared to the crystal materials such as an electromagnetic soft iron, permalloy, Sendust, a silicon metal plate or the like. When the soft magnetic amorphous alloy is applied to the dust core of the present invention, the excessive current loss can be suppressed and the efficient high frequency property can be achieved. As described above, by adding an appropriate amount of L element such as Cr or Nb to the soft magnetic amorphous alloy of the present invention, the corrosion resistance of the soft magnetic amorphous alloy is improved and spherical powder having a smooth surface is provided. The binder used in the present invention also insulates between powders. If an amount of the binder to be added is small, an insulation resistance of the dust core becomes low and the strength of the dust core is reduced. If too much amount of the binder is added, reduction of the magnetic property is caused because the content of amorphous magnetic powder is reduced. Therefore, it is preferable to maintain the amount of insulation material to be added is in a range from 1 wt % to 5 wt % of the entire weight. A lubricant may be added in order to improve the formability. Generally, a cold forming process is carried out as a forming process. However, a heat forming process may be carried out near the supercooled liquid region at a temperature lower than the crystallization temperature, whereby amorphous powder generate a viscous flow so that the dust core having a high density can be obtained. The dust core may be arranged near a coil to be used as an inductor. Since amorphous powder of the present embodiment has an efficient soft magnetic property, an excessive current loss can be suppressed and the inductor having high efficiency can be manufactured.

A soft magnetic amorphous ribbon or a soft magnetic amorphous piece of the present embodiment has a coercive force in a range from 0.1 A/m to 2.5 A/m. The conventional Fe-based amorphous alloy or Fe-based metallic glass has a coercive force in a range from 3 A/m to 5 A/m. The soft magnetic amorphous alloy of the present embodiment has a soft magnetic property superior to the conventional Fe-based amorphous alloy or Fe-based metallic glass. The soft magnetic amorphous alloy of the present embodiment has a large magnetostriction in a range from 20 to 30×10⁻⁶. For this reason, it is difficult to obtain the coercive force lower than 0.1 A/m. The ribbon or the piece may be obtained by a single-roll method or a twin-roll method. However, the present invention is not limited to these methods.

The soft magnetic amorphous alloy according to the present embodiment may be a ribbon or a piece. When the ribbon or the piece is to be used at a high frequency of several kHz or even higher, the thickness of the ribbon or the piece is preferably in a range from 0.01 to 0.1 mm in order to suppress the excessive current loss. When the use is at a utility frequency of about 50 Hz or lower, it is preferable that the ribbon or piece are made thick so that the number of laminations may be reduced or a space factor may be increased, but not that thick to increase the excessive current. When the thickness of ribbon or piece increases, a cooling rate of a surface of the amorphous ribbon becomes slow and it is difficult to become amorphous. Therefore, the thickness of the ribbon or the piece may be in a range from 0.1 mm to 1.0 mm. Fe-based amorphous alloy using the conventional commercial materials such as Fe—Si—B alloy has a poor capability of forming an amorphous phase so that the thickness of 0.02 or 0.03 mm may be the limit of the manufacturing capability. By using the soft magnetic amorphous alloy of the present embodiment, it is possible to stably manufacture the amorphous ribbons having a thickness of 0.1 mm or higher even by the single-roll method which is a useful and superior method for mass-production. In case of manufacturing the thin ribbons having a thickness of 0.01 to 0.1 mm, it is preferable to have the high capability of forming an amorphous phase just like the soft magnetic amorphous alloy of the present invention, in view of the improvements of the magnetic property due to homogenization of the amorphous structure and also the improvement of the yield due to the suppression of crystallization.

A wound magnetic core or a multilayer magnetic core may be manufactured by using the ribbon or the piece mentioned above. By using the ribbon or the piece of the present embodiment, a magnetic core or a multilayer magnetic core having low loss and a high efficiency may be obtained.

An amorphous bulk member of the present embodiment has a thickness in a range from 0.5 mm and 3.0 mm. Fe-based amorphous as the conventional material has a low capability of forming an amorphous phase so that the thickness of the bulk member has been limited to 0.02 to 0.03 mm at the maximum. By using Fe-based metallic glass, the thickness of the bulk member may be 5 mm at the maximum. However, the saturation magnetic flux density is greatly reduced as the magnetic element, such as Fe, is reduced (see Non-Patent Document 7 and Non-Patent Document 8). On the contrary, the amorphous bulk member of the present embodiment uses the soft magnetic amorphous alloy wherein both the saturation magnetic flux density and a capability of forming an amorphous phase are compatibly obtained. Therefore, it is possible to manufacture the amorphous bulk member having a thickness of 3 mm at the maximum by using a metal-mold casting method or injection molding method.

The above-mentioned amorphous powder, the dust core, the inductor, the ribbon and the bulk member may be subjected to the heat treatment at 500° C. or lower in order to absorb an internal stress, thereby to improve the soft magnetic property. In addition to the above-mentioned heat treatment, the dust core or the inductor should be subjected to the heat treatment in order to harden the binder mixed therein. The heat treatment may cause the reduction in the magnetic property such as a core loss or a magnetic permeability, and reliability in the strength or the insulation resistance. Therefore, the heat treatment should be carried out at the temperature not higher than the heat resistivity of the binder, powder or a coating resin of the coil, which is, for example, at 450° C.

As thus far been described, the soft magnetic amorphous alloy of the present embodiment has, although being cooled at a relatively low cooling rate, a uniform amorphous structure. In addition, it has an efficient soft magnetic property because, due to the random structure, no magnetic crystalline anisotropy is present and also has no pinning sites which disturb the magnetic domain wall propagation. Accordingly, the amorphous powder, the amorphous ribbon, the amorphous piece and the amorphous bulk member can be easily manufactured. The dust core and the inductor using the amorphous powder, as well as the sound magnetic core and the multilayer magnetic core using the amorphous ribbon, have low loss and have high magnetic permeability, whereby the magnetic components having a small size and high capability can be provided.

In the process of manufacturing the soft magnetic amorphous alloy of the present embodiment, the conventional and general high frequency heating apparatus as well as a melting and rapidly cooling apparatus, a heat treatment apparatus, or a pressing apparatus may be used. As for the melting and rapidly cooling apparatus, any kinds of apparatuses may be used as long as an amorphous single phase is obtained from a molten master alloy without any crystallization. As for manufacturing powder, for example, a water atomization apparatus or a gas atomization apparatus may be used. As for manufacturing the ribbon, for example, a single-roll apparatus or a twin-roll apparatus may be used. As for manufacturing the bulk member, for example, the metal mold casting apparatus or an injection molding apparatus may be used. As for the heat treatment process, any kinds of electronic furnaces may be used as long as it is operable to adjust an atmosphere and to control the temperature up to 500° C. Moreover, general and conventional manufacturing apparatuses may be used to manufacture the dust core having various shapes obtained by processing the soft magnetic amorphous alloy and the inductor using the dust core.

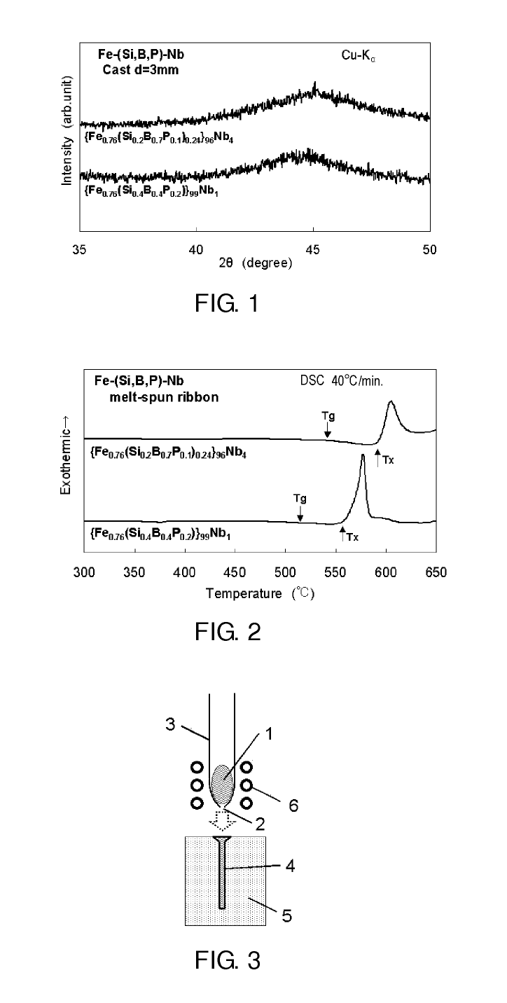

Evaluation has been carried out by an X-ray diffraction method for the crystal structure of powder or the ribbon to see whether it has “an amorphous phase” or “a crystal phase”. “The amorphous phase” represents the state of the phase wherein a broad peak is observed in a profile obtained by the X-ray diffraction method. “The crystal phase” represents the state of the phase wherein a peak due to the crystal phase is observed in a profile obtained by the X-ray diffraction method. Herein, samples used to evaluate the crystal structures have a composition formula of {Fe_{0.76}(Si_{0.4}B_{0.4}P_{0.2})}₉₉Nb₁ and {Fe_{0.76}(Si_{0.2}B_{0.7}P_{0.1})_{0.24}}₉₆Nb₄, respectively. Each of the soft magnetic amorphous alloys is formed into a mold rod-like member having a diameter of 3 mm. The evaluation has been performed for the mold rod-like member by the X-ray diffraction method. As shown in FIG. 1, only a broad peak appeared.

It is a characteristic of amorphous powder and the ribbon according to the present invention that a clear supercooled liquid region appears. The supercooled liquid region has been evaluated by a thermal analyses using a differential scanning calorimetry (DSC). A sample used for the evaluation by the thermal analysis are the amorphous ribbons represented by {Fe_{0.76}(Si_{0.4}B_{0.4}P_{0.2})}₉₉Nb₁ and {Fe_{0.76}(Si_{0.2}B_{0.7}P_{0.1})_{0.24}}₉₆Nb₄. Herein, a heating rate is set to 40° C./minute (0.67° C./second). As shown in FIG. 2, each supercooled liquid region (ΔTx) is calculated from “a glass transition temperature (Tg)” and “temperature at which crystallization starts (Tx)” of soft magnetic powder.

Depending upon application and required heat resistance, a proper binder can be selected as the binder of the dust core and the inductor of the present invention. Examples of the binder include epoxy resin, unsaturated polyester resin, phenol resin, xylene resin, diallyl phthalate resin, silicone resin, polyamide-imide, and polyimide. As a matter of course, however, the present invention is not limited to those Examples.

### Embodiment

### Examples 1-20 and Comparative Examples 1-8

Materials of Fe, Si, B, Fe₃P, Al, Cr, Zr, Nb, Mo, Hf, Ta and W were respectively weighed so as to provide samples. A list of compositions of Examples 1 to 20 of the present invention and Comparative Examples 1 to 6 is shown in Table 1. The manufactured samples are put into an alumina crucible and then placed within a vacuum chamber of a high-frequency induction heating apparatus. Then the vacuum chamber was evacuated. Then the materials were melted within a reduced-pressure Ar atmosphere by high-frequency induction heating to produce master alloys. The master alloys were processed by a single-roll liquid quenching method so as to produce continuous ribbons. The continuous ribbons have a thickness of 20 μm, a width of about 3 mm, and a length of about 5 m. The master alloy is processed by a metal mold casting method to manufacture a mold rod-like member. The mold rod-like member has a diameter of 1 to 4 mm and a length of 50 mm. The mold rod-like member was manufactured by using an apparatus shown in FIG. 3. The master alloy 1 is put into a quartz nozzle 3 having a small hole 2 at its end. The quartz nozzle 3 is placed right above a copper mold 5 having a mold 4 as a molding space, which has a diameter of 1 mm to 4 mm and a length of 50 mm. Heat melting is carried out by a high-frequency generator coil 6, and then the molten master alloy 1 in the quartz nozzle 3 is spouted from the small hole 2 by a pressurized argon gas and poured into the mold 4 of the copper mold 5. The master alloy is left in that state and solidified. Thus, a rod-like sample is produced. By using a X-ray diffraction method, a phase on a surface of each mold rod-like member was evaluated about whether it has “an amorphous phase” or “a crystal phase”. Measurement of the maximum diameter dₘₐₓ was carried out for the mold rod-like member which has the amorphous phase. Herein, an increase of the maximum diameter dₘₐₓ means that an amorphous structure can be obtained with a low cooling rate and also the amorphous structure has a high capability of forming an amorphous phase. By using a vibrating-sample magnetometer (VSM), a saturation magnetic flux density was evaluated for the ribbon having a thickness of 20 μm with an amorphous single phase. In addition, a supercooled liquid region ΔTx was evaluated by using a differential scanning calorimetry (DSC). Table 1 shows results of the measurements of the saturation magnetic flux density Bs, the maximum diameter dₘₐₓ, the supercooled liquid region ΔTx of the soft magnetic amorphous alloy composition of Examples 1 to 20 of the present invention and Comparative Examples 1 to 8.

TABLE 1

| | Alloy Composition | | Maximum | |
|---|---|---|---|---|
| | (at %) | Bs [T] | diameter [mm] | ΔTx [° C.] |
| Comparative | {Fe_{0.76}(Si_{0.0}B_{0.8}P_{0.2})_{0.24}}₉₈Nb₂ | 1.38 | <1 | 26 |
| Example 1 | | | | |
| Example 1 | {Fe_{0.76}(Si_{0.05}B_{0.75}P_{0.2})_{0.24}}₉₈Nb₂ | 1.37 | 1 | 28 |
| Example 2 | {Fe_{0.76}(Si_{0.3}B_{0.5}P_{0.2})_{0.24}}₉₈Nb₂ | 1.38 | 3 | 46 |
| Example 3 | {Fe_{0.76}(Si_{0.6}B_{0.2}P_{0.2})_{0.24}}₉₈Nb₂ | 1.37 | 1 | 22 |
| Comparative | {Fe_{0.76}(Si_{0.7}B_{0.1}P_{0.2})_{0.24}}₉₈Nb₂ | 1.35 | <1 | 0 |
| Example 2 | | | | |
| Comparative | {Fe_{0.76}(Si_{0.5}B_{0.0}P_{0.5})_{0.24}}₉₈Nb₂ | 1.27 | <1 | 0 |
| Example 3 | | | | |
| Example 4 | {Fe_{0.76}(Si_{0.4}B_{0.1}P_{0.5})_{0.24}}₉₈Nb₂ | 1.29 | 1 | 23 |
| Example 5 | {Fe_{0.76}(Si_{0.2}B_{0.5}P_{0.3})_{0.24}}₉₈Nb₂ | 1.37 | 3 | 44 |
| Example 6 | {Fe_{0.76}(Si_{075.0}B_{0.85}P_{0.075})_{0.24}}₉₈Nb₂ | 1.40 | 1 | 22 |
| Comparative | {Fe_{0.76}(Si_{0.05}B_{0.9}P_{0.05})_{0.24}}₉₈Nb₂ | 1.40 | <1 | 0 |
| Example 4 | | | | |
| Comparative | {Fe_{0.76}(Si_{0.3}B_{0.7}P_{0.0})_{0.24}}₉₈Nb₂ | 1.39 | <1 | 0 |
| Example 5 | | | | |
| Example 7 | {Fe_{0.76}(Si_{0.3}B_{0.65}P_{0.05})_{0.24}}₉₈Nb₂ | 1.39 | 1 | 32 |
| Example 8 | {Fe_{0.76}(Si_{0.3}B_{0.5}P_{0.2})_{0.24}}₉₈Nb₂ | 1.38 | 3 | 46 |
| Example 9 | {Fe_{0.76}(Si_{0.1}B_{0.2}P_{0.7})_{0.24}}₉₈Nb₂ | 1.29 | 1 | 30 |
| Comparative | {Fe_{0.76}(Si_{0.1}B_{0.1}P_{0.8})_{0.24}}₉₈Nb₂ | 1.25 | <1 | 23 |
| Example 6 | | | | |
| Example 10 | {Fe_{0.76}(Si_{0.4}B_{0.4}P_{0.2})_{0.24}}_{99.5}Nb_{0.5} | 1.49 | 2 | 48 |
| Example 11 | {Fe_{0.76}(Si_{0.4}B_{0.4}P_{0.2})_{0.24}}₉₉Nb₁ | 1.45 | 3 | 53 |
| Example 12 | {Fe_{0.76}(Si_{0.3}B_{0.5}P_{0.2})_{0.24}}₉₈Nb₂ | 1.38 | 3 | 46 |
| Example 13 | {Fe_{0.76}(Si_{0.2}B_{0.7}P_{0.1})_{0.24}}₉₅Nb₅ | 1.20 | 3 | 56 |
| Comparative | {Fe_{0.76}(Si_{0.2}B_{0.7}P_{0.1})_{0.24}}₉₄Nb₆ | 1.11 | 1 | 60 |
| Example 7 | | | | |
| Example 14 | {Fe_{0.76}(Si_{0.3}B_{0.5}P_{0.2})_{0.24}}₉₈Nb₁Cr₁ | 1.39 | 3 | 48 |
| Example 15 | {Fe_{0.76}(Si_{0.3}B_{0.5}P_{0.2})_{0.24}}₉₈Nb₁Al₁ | 1.47 | 2 | 42 |
| Example 16 | {Fe_{0.76}(Si_{0.3}B_{0.5}P_{0.2})_{0.24}}₉₈Nb₁Zr₁ | 1.41 | 2 | 41 |
| Example 17 | {Fe_{0.76}(Si_{0.3}B_{0.5}P_{0.2})_{0.24}}₉₈Nb₁Mo₁ | 1.39 | 3 | 53 |
| Example 18 | {Fe_{0.76}(Si_{0.3}B_{0.5}P_{0.2})_{0.24}}₉₈Nb₁Hf₁ | 1.37 | 2 | 48 |
| Example 19 | {Fe_{0.76}(Si_{0.3}B_{0.5}P_{0.2})_{0.24}}₉₈Nb₁Ta₁ | 1.37 | 2 | 44 |
| Example 20 | {Fe_{0.76}(Si_{0.3}B_{0.5}P_{0.2})_{0.24}}₉₈Nb₁W₁ | 1.35 | 1 | 47 |
| Comparative | Fe₇₈Si₉B₁₃ | 1.55 | <1 | 0 |
| Example 8 | | | | |

As shown in Table 1, each of the amorphous alloy compositions of Examples 1 to 20 had the saturation magnetic flux density Bs of at least 1.20 T, had the higher capability of forming an amorphous phase as compared to Comparative Example 8, which is a conventional amorphous composition including the Fe, Si, and B elements, and had the maximum diameter dₘₐₓ of at least 1 mm and the supercooled liquid region ΔTx at about 20° C. or higher.

In the compositions listed in Table 1, the compositions of Examples 1 to 3 and Comparative Examples 1 and 2 correspond to cases where a value x of the Si content in {FeₐSiₓB_{y}P_{z})₁₋ₐ}_{100-b}L_{b} is varied from 0 to 0.7. The cases of Examples 1 to 3 met conditions of Bs≧1.20 T, dₘₐₓ≧1 mm, and ΔTx≧20° C. In the case of Comparative Examples 1 and 2 where x=0, 0.7, the capability of forming an amorphous phase is lowered. Moreover, in the case of Comparative Example 2, the supercooled liquid region ΔTx is less than 20° C. and the aforementioned conditions were not met. Therefore, a range of the condition of the parameter x of the present invention is set in a range of 0.05≦x≦0.6.

In the compositions listed in Table 1, the compositions of Examples 4 to 6 and Comparative Examples 3 and 4 correspond to cases where a value y of a B content in {FeₐSiₓB_{y}P_{z})₁₋ₐ}_{100-b}L_{b} is varied from 0 to 0.9. The cases of Examples 4 to 6 met conditions of Bs≧1.20 T, dₘₐₓ≧1 mm, and ΔTx≧20° C. In the case of Comparative Examples 3 and 4 where y=0, 0.9, the capability of forming an amorphous phase was lowered. Moreover, the supercooled liquid region ΔTx is less than 20° C. and the aforementioned conditions were not met. Therefore, the range of the condition of the parameter y of the present invention is set in a range of 0.1≦y≦0.85.

In the compositions listed in Table 1, the compositions of Examples 7 to 9 and Comparative Examples 5 and 6 correspond to cases where a value z of a P content in {FeₐSiₓB_{y}P_{z})₁₋ₐ}_{100-b}L_{b} is varied from 0 to 0.8. The cases of Examples 7 to 9 met the conditions of Bs≧1.20 T, dₘₐₓ≧1 mm, and ΔTx≧20° C. In the cases of Comparative Examples 5 and 6 where z=0, 0.8, the capability of forming an amorphous phase was lowered. Moreover, in the case of Comparative Example 5, the supercooled liquid region ΔTx is less than 20° C. and the aforementioned conditions were not met. Therefore, the range of the condition of the parameter z of the present invention is set in a range of 0.05≦z≦0.75.

In the compositions listed in Table 1, the compositions of Examples 10 to 20 and Comparative Example 7 correspond to cases where the value b of the L content in {FeₐSiₓB_{y}P_{z})₁₋ₐ}_{100-b}L_{b} is varied from 0.5 to 6 atomic %. The cases of Examples 10 to 20 met the conditions of Bs≧1.20 T, dₘₐₓ≧1 mm, and ΔTx≧20° C. In the case of Comparative Example 7 where b=6 atomic %, the saturation magnetic flux density Bs is reduced and the aforementioned conditions were not met. Therefore, the range of the condition of the parameter b of the present invention is set to b≦5 atomic %.

### Examples 21-34, Comparative Example 9, 10

Materials of Fe, Si, B, Fe₃P, Al, Cr, Zr, Nb, Mo, Hf, Ta and W were respectively weighed so as to provide samples. A list of compositions of Examples 21 to 34 of the present invention and Comparative Examples 9 and 10 is shown in Table 2. Master alloys were manufactured in the manner similar to Examples 1 to 20 of the present invention and Comparative Examples 1 to 8. The master alloys were processed by a single-roll liquid quenching method so as to produce continuous ribbons. The continuous ribbons have a thickness of 30 μm, a width of about 10 mm, and a length of about 2 m. The surface of the ribbons were subjected to the X-ray diffraction analysis to evaluate whether to have an amorphous phase. For the ribbons which are evaluated as having the amorphous phase, further evaluation has been carried out for the saturation magnetic flux density Bs by using the vibrating-sample magnetometer (VSM). Moreover, each continuous ribbon was cut into a length of about 30 mm, which was subjected to a constant-temperature high-humidity test under conditions of 60° C. and 95% RH. The existence of corrosions on a surface of the ribbon was evaluated after 24 hours and after 100 hours, respectively. Table 2 shows the observation results of the constant-temperature high-humidity test and the saturation magnetic flux density Bs of the soft magnetic amorphous alloy compositions according to Examples 21 to 34 of the present invention and Comparative Example 9 and 10.

TABLE 2

| | Alloy Composition | State of surface of Ribbon | | Bs |
|---|---|---|---|---|
| | (at %) | after 24 hrs. | after 100 hrs. | [T] |
| Example 21 | {Fe_{0.76}(Si_{0.3}B_{0.5}P_{0.2})_{0.24}}_{99.7}Cr_{0.3} | total corrosion | total corrosion | 1.52 |
| Example 22 | {Fe_{0.76}(Si_{0.3}B_{0.5}P_{0.2})_{0.24}}_{99.5}Nb_{0.2}Cr_{0.3} | partial | total corrosion | 1.51 |
| | | corrosion | | |
| Example 23 | {Fe_{0.76}(Si_{0.3}B_{0.5}P_{0.2})_{0.24}}₉₉Nb_{0.5}Cr_{0.5} | no corrosion | partial corrosion | 1.47 |
| Example 24 | {Fe_{0.76}(Si_{0.3}B_{0.5}P_{0.2})_{0.24}}₉₈Nb₁Cr₁ | no corrosion | no corrosion | 1.39 |
| Example 25 | {Fe_{0.76}(Si_{0.3}B_{0.5}P_{0.2})_{0.24}}₉₅Nb_{2.5}Cr_{2.5} | no corrosion | no corrosion | 1.23 |
| Comparative | {Fe_{0.76}(Si_{0.3}B_{0.5}P_{0.2})_{0.24}}₉₄Nb₃Cr₃ | no corrosion | no corrosion | 1.15 |
| Example 9 | | | | |
| Example 26 | {Fe_{0.76}(Si_{0.3}B_{0.5}P_{0.2})_{0.24}}₉₉Nb₁ | total corrosion | total corrosion | 1.47 |
| Example 27 | {Fe_{0.76}(Si_{0.3}B_{0.5}P_{0.2})_{0.24}}₉₉Nb_{0.7}Cr_{0.3} | partial | total corrosion | 1.48 |
| | | corrosion | | |
| Example 28 | {Fe_{0.76}(Si_{0.3}B_{0.5}P_{0.2})_{0.24}}₉₉Nb_{0.5}Cr_{0.5} | no corrosion | partial corrosion | 1.47 |
| Example 29 | {Fe_{0.76}(Si_{0.3}B_{0.5}P_{0.2})_{0.24}}₉₉Nb_{0.3}Cr_{0.7} | no corrosion | partial corrosion | 1.48 |
| Example 30 | {Fe_{0.76}(Si_{0.3}B_{0.5}P_{0.2})_{0.24}}₉₉Cr₁ | no corrosion | partial corrosion | 1.48 |
| Example 31 | {Fe_{0.76}(Si_{0.3}B_{0.5}P_{0.2})_{0.24}}₉₅Cr₅ | no corrosion | no corrosion | 1.22 |
| Example 32 | {Fe_{0.76}(Si_{0.3}B_{0.5}P_{0.2})_{0.24}}₉₉Al_{0.3}Cr_{0.5} | no corrosion | partial corrosion | 1.51 |
| Example 33 | {Fe_{0.76}(Si_{0.3}B_{0.5}P_{0.2})_{0.24}}₉₉Nb_{0.5}Cr_{0.5} | no corrosion | partial corrosion | 1.47 |
| Example 34 | {Fe_{0.76}(Si_{0.3}B_{0.5}P_{0.2})_{0.24}}₉₉Mo_{0.5}Cr_{0.5} | no corrosion | partial corrosion | 1.47 |
| Comparative | Fe₇₈Si₉B₁₃ | total corrosion | total corrosion | 1.55 |
| Example 10 | | | | |

As shown in Table, 2, each of the amorphous alloy compositions of Examples 21 to 34 had a saturation magnetic flux density Bs of at least 1.20 T. Especially in the soft magnetic amorphous alloy of Examples 22 to 25 and Examples 27 to 34 exhibited improvements in the corrosion resistance as a result of the constant-temperature high-humidity test.

Among the compositions listed in Table 2, the compositions of Examples 21 to 25 and Comparative Example 9 correspond to cases where L element in (FeₐSiₓB_{y}P_{z})₁₋ₐ)_{100-b}L_{b} is varied from 0.3 to 6.0 atomic %. The cases of Examples 21 to 25 met the conditions of Bs≧1.20 T. In case of Examples 22 to 25, improvements in the corrosion resistance is met. In Comparative Example 10 and Example 21 where b=0, 0.3, the corrosion resistance is not improved. Therefore, in order to improve the corrosion resistance, the range of the parameter b is set to 0.05≦b≦5.0. Moreover, in Examples 23 to 25, no corrosion is observed on a surface of the ribbons after 24 hours, and the high corrosion resistance is exhibited. Therefore, it is preferable that the parameter b is in a range of 0.05≦b≦5.0 when the high corrosion resistance is required.

In a compositions listed in Table 2, the compositions of Examples 26 to 34 correspond to cases where Cr element within L element in (FeₐSiₓB_{y}P_{z})₁₋ₐ)_{100-b}L_{b} is varied from 0 to 5.0 atomic %. The cases of Examples 26 to 34 met the condition of Bs≧1.20 T. Especially in cases of Examples 27 to 34, an improvement in the corrosion resistance is met. Therefore, percentage of Cr element contained in L element is preferably in a range from 0.3 atomic % to 5.0 atomic %. Moreover, in Examples 28 to 34, no corrosion is observed on a surface of the ribbon after 24 hours, and the high corrosion resistance were exhibited. Therefore, the percentage of Cr element contained in L element is preferably in a range from 0.5 atomic % to 5.0 atomic % when the high corrosion resistance is required.

### Example 35

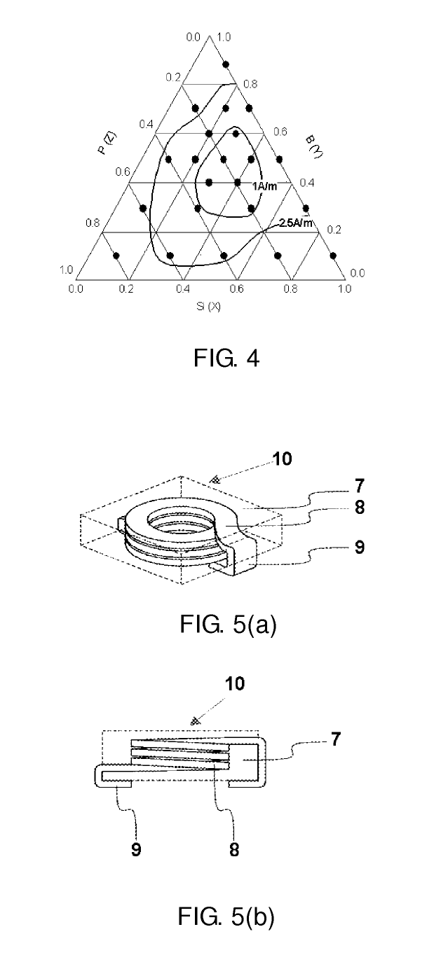

Materials of Fe, Si, B, Fe₃P, and Nb are weighed so as to provide samples. A composition of the samples met {Fe_{0.76}(Si_{0.4}B_{0.4}P_{0.2})}₉₉Nb₁. A value of x, y, and z is set to the values as shown in FIG. 4. As a Comparative Example, components are weighed and made into Fe₇₈Si₉B₁₃ alloy composition. Next, master alloys were manufactured in the manner similar to Examples 1 to 20 of the present invention and Comparative Examples 1 to 8. The master alloys were processed by a single-roll liquid quenching method so as to produce the continuous ribbons. The continuous ribbons have a width of about 5 mm, a thickness of 20 μm, and a length of about 20 m. The ribbons are processed into wound magnetic cores each having an inner diameter of 14 mm and an outer diameter of 20 mm. The wound magnetic cores having supercooled liquid region are subjected to heat treatment for 5 minutes at a temperature lower than a glass transition temperature by 30° C. For the wound magnetic cores having no supercooled liquid region, heat treatment was carried out for 60 minutes at 400° C. within Ar atmosphere. After the heat treatment, measurement has been carried out for the coercive force Hc by using a direct current BH tracer. As shown in FIG. 4, the composition within a range of the present invention has coercive force Hc smaller than 2.5 A/m and exhibited an efficient property. The comparative material Fe₇₈Si₉B₁₃ has coercive force Hc of 10 A/m.

### Examples 36-66, Comparative Example 11-17

Materials of Fe, Si, B, Fe₃P, Nb and Cr were respectively weighed so as to provide Examples. A list of compositions of samples as Examples 36 to 66 and Comparative Examples 11 to 17 are listed in Table 3. By using the manufactured samples, master alloys were manufactured in a manner similar to Examples 1 to 20 and Comparative Examples 1 to 8. Next, the master alloys were processed by a single-roll liquid quenching method so as to produce continuous ribbons having various thicknesses, a width of about 3 mm, and a length of about 5 m. Each ribbon is evaluated by an X-ray diffraction method with regard to a surface of the ribbon that did not contact with copper rolls at the time of quenching at which a cooling rate of the ribbon became the lowest. Based on the result of the evaluation, the maximum thickness tₘₐₓ was measured for each ribbon. An increase of the maximum thickness tₘₐₓ means that an amorphous structure can be obtained with a low cooling rate and that the amorphous structure has a high capability of forming an amorphous phase.

The master alloys were processed by a single-roll liquid quenching method so as to produce continuous ribbons. The continuous ribbons have a width of about 5 mm, a thickness of 20 μm, and a length of about 20 m. The ribbons are processed into wound magnetic cores in a manner similar to Example 35. Then heat treatment was carried out and the coercive force Hc was measured. Moreover, the saturation magnetic flux density Bs was evaluated by using the VSM.

The master alloys were processed by a single-roll liquid quenching method so as to produce continuous ribbons. The continuous ribbons have a width of about 10 mm, a thickness of 30 μm, and a length of about 2 m. Moreover, each continuous ribbon was cut into a length of about 30 mm, which was subjected to a constant-temperature high-humidity test under conditions of 60° C. and 95% RH. The presence of the corrosion on a surface of the ribbon was evaluated after 24 hours and after 100 hours, respectively. Table 3 shows the observation results of the coercive force Hc, the maximum thickness tₘₐₓ, and the saturation magnetic flux density Bs of the soft magnetic amorphous alloy composition according to the composition of Examples 36 to 66 of the present invention and Comparative Examples 11 to 17.

TABLE 3

| | | tₘₐₓ | Hc | Bs | state of surface |
|---|---|---|---|---|---|
| | Alloy Composition (at %) | (μm) | [A/m] | [T] | after 24 hours |
| Comparative | Fe₇₆(Si_{0.3}B_{0.5}P_{0.2})₂₄ | 190 | 0.8 | 1.54 | total corrosion |
| Example 11 | | | | | |
| Comparative | Fe_{68.5}(Si_{8/23}B_{9/23}P_{6/23})₃₁Cr_{0.5} | 60 | 2.4 | 1.17 | partial corrosion |
| Example 12 | | | | | |
| Example 36 | Fe_{70.5}(Si_{8/23}B_{9/23}P_{6/23})₂₉Cr_{0.5} | 120 | 2.1 | 1.26 | partial corrosion |
| Example 37 | Fe_{75.5}(Si_{8/23}B_{9/23}P_{6/23})₂₄Cr_{0.5} | 190 | 1.0 | 1.49 | partial corrosion |
| Example 38 | Fe_{76.5}(Si_{8/23}B_{9/23}P_{6/23})₂₃Cr_{0.5} | 150 | 0.6 | 1.51 | partial corrosion |
| Example 39 | Fe_{77.5}(Si_{8/23}B_{9/23}P_{6/23})₂₂Cr_{0.5} | 120 | 0.8 | 1.54 | partial corrosion |
| Example 40 | Fe_{78.5}(Si_{8/23}B_{9/23}P_{6/23})₂₁Cr_{0.5} | 110 | 1.5 | 1.56 | partial corrosion |
| Example 41 | Fe_{79.5}(Si_{8/23}B_{9/23}P_{6/23})₂₀Cr_{0.5} | 80 | 2.2 | 1.58 | partial corrosion |
| Example 42 | Fe_{80.5}(Si_{8/23}B_{9/23}P_{6/23})₁₉Cr_{0.5} | 50 | 1.9 | 1.59 | partial corrosion |
| Example 43 | Fe_{81.5}(Si_{8/23}B_{9/23}P_{6/23})₁₈Cr_{0.5} | 40 | 2.4 | 1.62 | partial corrosion |
| Comparative | Fe_{82.5}(Si_{8/23}B_{9/23}P_{6/23})₁₇Cr_{0.5} | 25 | 2.8 | 1.64 | total corrosion |
| Example 13 | | | | | |
| Example 44 | Fe_{77.5}Si₁₂B₇P₃Cr_{0.5} | 60 | 2.4 | 1.56 | partial corrosion |
| Example 45 | Fe_{77.5}Si₁₀B₇P₅Cr_{0.5} | 130 | 1.0 | 1.52 | partial corrosion |
| Example 46 | Fe_{77.5}Si₈B₅P₉Cr_{0.5} | 100 | 1.4 | 1.5 | partial corrosion |
| Example 47 | Fe_{77.5}Si₈B₇P₇Cr_{0.5} | 130 | 1.0 | 1.52 | partial corrosion |
| Example 48 | Fe_{77.5}Si₈B₉P₅Cr_{0.5} | 140 | 1.0 | 1.54 | partial corrosion |
| Example 49 | Fe_{77.5}Si₈B₁₂P₂Cr_{0.5} | 50 | 2.2 | 1.56 | partial corrosion |
| Example 50 | Fe_{77.5}Si₆B₇P₉Cr_{0.5} | 140 | 1.2 | 1.48 | partial corrosion |
| Example 51 | Fe_{77.5}Si₆B₉P₇Cr_{0.5} | 160 | 0.7 | 1.52 | partial corrosion |
| Example 52 | Fe_{77.5}Si₆B₁₁P₅Cr_{0.5} | 110 | 1.0 | 1.55 | partial corrosion |
| Example 53 | Fe_{77.5}Si₄B₇P₁₁Cr_{0.5} | 120 | 1.3 | 1.49 | partial corrosion |
| Example 54 | Fe_{77.5}Si₄B₉P₉Cr_{0.5} | 140 | 0.9 | 1.51 | partial corrosion |
| Example 55 | Fe_{77.5}Si₄B₁₁P₇Cr_{0.5} | 150 | 1.0 | 1.53 | partial corrosion |
| Example 56 | Fe_{77.5}Si₄B₁₃P₅Cr_{0.5} | 110 | 1.4 | 1.55 | partial corrosion |
| Example 57 | Fe_{77.5}Si₄B₁₅P₃Cr_{0.5} | 90 | 1.9 | 1.56 | partial corrosion |
| Example 58 | Fe_{77.5}Si₂B₁₃P₇Cr_{0.5} | 60 | 1.3 | 1.51 | partial corrosion |
| Example 59 | Fe_{77.5}Si₄B₅P₁₃Cr_{0.5} | 70 | 1.8 | 1.49 | partial corrosion |
| Example 60 | Fe_{77.5}Si₃B₄P₁₅Cr_{0.5} | 45 | 2.2 | 1.48 | partial corrosion |
| Comparative | Fe_{77.5}Si₂B₃P1₇Cr_{0.5} | 25 | 6 | 1.45 | partial corrosion |
| Example 14 | | | | | |
| Comparative | Fe_{77.5}Si₁₃B₁₃P₉Cr_{0.5} | 30 | 6 | 1.48 | partial corrosion |
| Example 15 | | | | | |
| Example 61 | Fe_{77.5}Si₆B₉P₇Cr_{0.5} | 160 | 0.7 | 1.52 | partial corrosion |
| Example 62 | Fe_{67.5}CO₁₀Si₆B₉P₇Cr_{0.5} | 180 | 0.8 | 1.49 | partial corrosion |
| Example 63 | Fe_{67.5}Ni₁₀Si₆B₉P₇Cr_{0.5} | 160 | 1.2 | 1.42 | partial corrosion |
| Example 64 | Fe_{57.5}Co₂₀Si₆B₉P₇Cr_{0.5} | 170 | 1.1 | 1.35 | partial corrosion |
| Example 65 | Fe_{47.5}Co₃₀Si₆B₉P₇Cr_{0.5} | 170 | 2.1 | 1.28 | partial corrosion |
| Example 66 | Fe_{37.5}Co₄₀Si₆B₉P₇Cr_{0.5} | 140 | 2.4 | 1.21 | partial corrosion |
| Comparative | Fe_{27.5}Co₅₀Si₆B₉P₇Cr_{0.5} | 140 | 2.4 | 1.13 | partial corrosion |
| Example 16 | | | | | |
| Comparative | Fe₇₈Si₉B₁₃ | 40 | 10 | 1.55 | total corrosion |
| Example 17 | | | | | |

As shown in Table 3, each of amorphous alloy compositions of Examples 36 to 66 had a saturation magnetic flux density Bs of at least 1.20 T. As compared to Comparative Example 17, which is a conventional amorphous composition including the Fe, Si, and B elements, a capability of forming an amorphous phase is high, has a maximum thickness tₘₐₓ of at least 40 μm, has a coercive force Hc of lower than 2.5 A/m, and exhibits improvements in the corrosion resistance as a result of a constant-temperature high-humidity test

In the compositions listed in Table 3, the compositions of Examples 36 to 60 and Comparative Examples 11 to 15 correspond to cases where value a as a content of Fe element in (Feₐ(SiₓB_{y}P_{z})₁₋ₐ)_{100-b}L_{b} is varied from 0.688 to 0.829. The cases of Examples 36 to 60 met conditions of Bs≧1.20 T, tₘₐₓ≧40 μm, Hc≦2.5 A/m, and an improvement in the corrosion resistance. In case of Comparative Example 12 where a=0.688, the saturation magnetic flux density is reduced. Moreover, in Comparative Example 13 where a=0.829, the capability of forming an amorphous phase is reduced, the coercive force Hc exceeds 2.5 A/m, and no improvements in the corrosion resistance is exhibited, thereby the above-mentioned conditions are not met. Therefore, the range of the condition of parameter a is set to 0.7≦a≦0.82.

In the compositions listed in Table 3, the compositions of Examples 61 to 66 and Comparative Example 16 correspond to cases where Co content and Ni content of Fe element in (Feₐ(SiₓB_{y}P_{z})₁₋ₐ)_{100-b}L_{b} is varied from 0 to 65%. The cases of Examples 61 to 66 met the conditions of Bs≧1.20 T, tₘₐₓ≧40 μm, Hc≦2.5 A/m, and improvements in the corrosion resistance. In case of Comparative Example 16 where the percentage of Co and/or Ni content is 65%, the saturation magnetic flux density is reduced so that the above-mentioned conditions are not met. Therefore, it is preferable that percentage of condition of Co, Ni content of Fe according to the present invention is 0 to 50%.

The compositions of Examples 1 to 66 in the above-mentioned Tables 1 to 3 are made by adjusting a content amount of L element with paying careful attention to a content amount of P element. In the above-mentioned composition, the content of P element is defined by U=z(1-a)(100-b). As shown in Tables 1 to 3, Examples 1 to 66 correspond to cases where value U/b is varied from 0.45 to 30. In all Examples, the condition of Bs≧1.20 T, tₘₐₓ≧40 μm, Hc≦2.5 A/m, and improvements in the corrosion resistance are met. Therefore, the range of the condition of U/b of the present invention is set to a range from 0.45 to 30.

When Cr is added as L element, content amount of Cr element within the entire amount is represented by b_{Cr} as shown in Tables 2 and 3. In this case, U/b_{Cr} is preferably in a range from 0.9 to 30. When Nb is added as L element, content amount of Nb element within the entire amount is represented by b_{Nb} as shown in Tables 2 and 3. In this case, U/b_{Nb} is preferably be in a range from 0.45 to 24. As a result, amorphous alloy having the efficient corrosion resistance may be obtained.

### Examples 67-71, Comparative Examples 18 and 19

Materials of Fe, Si, B, Fe₃P, Nb, and Cr were respectively weighed so as to provide samples. A list of compositions of samples as Examples 67 to 71 and Comparative Examples 18 and 19 are listed in Table 4. Master alloys were manufactured in a manner similar to Examples 1 to 20 and Comparative Examples 1 to 8. The master alloys were processed by a water atomization method to obtain soft magnetic powder. Then an X-ray diffraction analysis was carried out for powder having an average grain diameter of 10 μm so as to determine the phase thereof. Powder which has been determined as having “the amorphous phase” is evaluated for the saturation magnetic flux density Bs by using a vibrating sample magnetometer (VSM). Then the surface of powder after the water atomization is observed. Table 4 shows the observation results of the X-ray diffraction analysis, the measurement result of the saturation magnetic flux density Bs, and the observation result of the surface of the powder after the water atomization according to the compositions of Examples 67 to 71 of the present invention and Comparative Examples 18 and 19.

TABLE 4

| | Alloy Composition | X-ray Diffraction | Bs | |
|---|---|---|---|---|
| | (at %) | Results | (T) | State of surface |
| Example 67 | {Fe_{0.76}(Si_{0.3}B_{0.5}P_{0.2})_{0.24}}₉₈Nb₂ | Amorphous Phase | 1.37 | no discoloration |
| Example 68 | {Fe_{0.76}(Si_{0.3}B_{0.5}P_{0.2})_{0.24}}₉₈Nb₁Cr₁ | Amorphous Phase | 1.37 | no discoloration |
| Example 69 | {Fe_{0.76}(Si_{0.3}B_{0.5}P_{0.2})_{0.24}}₉₈Cr₂ | Amorphous Phase | 1.38 | no discoloration |
| Example 70 | Fe_{77.5}Si₆B₉P₇Cr_{0.5} | Amorphous Phase | 1.51 | no discoloration |
| Example 71 | Fe_{78.5}Si₄B₉P₈Cr_{0.5} | Amorphous Phase | 1.52 | no discoloration |
| Comparative | Fe₇₆(Si_{0.3}B_{0.5}P_{0.2})₂₄ | Amorphous Phase | 1.54 | discolored |
| Example 18 | | | | |
| Comparative | Fe₇₈Si₉B₁₃ | Crystal Phase | — | discolored |
| Example 19 | | | | |

As shown in Table 4, Examples 67 to 71 can be easily made by powder having amorphous single phase. Each powder meets the conditions of the saturation magnetic flux density of Bs≧1.20 T, the core loss of Pcv≦4900 mW/cc, and improvements in the corrosion resistance. In case of Comparative Example 17 which does not contain L element, powder was discolored after the water atomization. Herein, discoloration of the surface means that the corrosion was generated. It is to be understood that Comparative Example 18 is inferior in the corrosion resistance. In case of Comparative Example 19 which is a conventional amorphous composition including the Fe, Si, and B elements, amorphous powder could not be obtained, powder after the water atomization was corroded, and is inferior in the corrosion resistance.

### Examples 72-78, Comparative Examples 20-22

Materials of Fe, Si, B, Fe₃P, Nb, and Cr were respectively weighed so as to provide samples. A list of compositions of samples as Examples 72 to 78 and Comparative Examples 20 to 22 are listed in Table 5. Master alloys were manufactured in a manner similar to Examples 1 to 20 and Comparative Examples 1 to 8. The master alloys were processed by a water atomization method and then classified so as obtain amorphous soft magnetic powder having an average grain diameter of 1 to 230 μm. An X-ray diffraction analysis was carried out for powder to determine that they have the amorphous phase. Subsequently, a solution of silicone resin was added as a binder to the powder. Granulation was performed along with mixing and mulling until the mixture was uniformized. The solvent was removed by drying, thereby producing granulated material powder. A weight ratio of the soft magnetic powder and the solid content of the silicone resin was 100/5 weight %. Then a dust core is manufactured under a pressure of 800 MPa to have an outer diameter of 18 mm, an inner diameter of 12 mm, and a height of 3 mm. Each mold compact is subjected to heat treatment for hardening silicone resin as the binder. Thereafter, Examples 72 to 76 were heated for 60 minutes under 450° C. and Examples 77 and 78 were heated for 60 minutes under 400° C. Fe powder and powder represented by a composition formula of Fe-3Si-8Cr (weight %) are both manufactured by the above-described method and are molded under the same condition as described above. The parts thus obtained are represented as Comparative Example 20 and 21, respectively. After winding wires are wound to each sample, measurement has been carried for a core loss of each sample by using an alternate current BH analyzer. Table 5 shows the X-ray diffraction analysis result and a core loss Pcv measurement result of amorphous powder as Examples 72 to 78 of the present invention and Comparative Examples 20 to 22.

TABLE 5

| | | Average | | |
|---|---|---|---|---|
| | | grain | X-ray | |
| | Alloy Composition | diameter | Diffraction | Pcv [mW/cc] |
| | (at %) | [μm] | Results | 100 kHz-100 mT |
| Example 72 | {Fe_{0.76}(Si_{0.3}B_{0.5}P_{0.2})_{0.24}}₉₈Nb₁Cr₁ | 1 | Amorphous | 760 |
| | | | Phase | |
| Example 73 | | 5 | Amorphous | 790 |
| | | | Phase | |
| Example 74 | | 10 | Amorphous | 980 |
| | | | Phase | |
| Example 75 | | 54 | Amorphous | 1120 |
| | | | Phase | |
| Example 76 | | 150 | Amorphous | 1380 |
| | | | Phase | |
| Comparative | | 230 | Crystal | — |
| Example 20 | | | Phase | |
| Example 77 | Fe_{77.5}Si₆B₉P₇Cr_{0.5} | 10 | Amorphous | 620 |
| | | | Phase | |
| Example 78 | Fe_{78.5}Si₄B₉P₈Cr_{0.5} | 10 | Amorphous | 880 |
| | | | Phase | |
| Comparative | Fe | 10 | — | 6320 |
| Example 21 | | | | |
| Comparative | Fe—3Si—8Cr (weight %) | 10 | — | 4900 |
| Example 22 | | | | |

As shown in Table 5, the soft magnetic amorphous alloy of Examples 72 to 78 have amorphous single phase and have a low core loss Pcv (≦4900 mW/cc) as compared to Fe of Comparative Example 21 or Fe-3Si-8Cr (weight %) of Comparative Example 22 which are both conventional materials for the magnetic core.

Among the compositions listed in Table 5, Examples 72 to 76 and Comparative Example 20 correspond to a case where an average grain diameter of soft magnetic powder used in the dust core is varied from 1 μm to 230 μm. The cases of Examples 72 to 76 met conditions of amorphous single phase and Pcv≦4900 mW/cc. In case of Comparative Example 20 where the average grain diameter is 230 μm, powder having amorphous single phase could not be obtained so it does not meet the above-mentioned condition. Therefore, the average grain diameter of the soft magnetic powder of the present invention is in a range from 1 μm to 150 μm.

### Examples 79 and 80 and Comparative Example 23

Next, description will be made about an embodiment of an inductor. The inductor is produced by providing the above-described dust core near a coil. Specifically, the inductor is an integrated inductor having the coil provided inside the dust core as shown in FIGS. 5(a) and (b). The inductor has a coil 8 made of three turns which is provided inside a dust core 7, and terminals for surface mounting 9 are exposed therefrom. In the drawing, an outline of the dust core 7 is denoted by a dashed line. A sample was weighed so as to have the composition of Fe, Si, B, Fe3P, Nb, and Cr. The composition of the sample is same as those of Examples 74 and 77. Next, master alloys were made for each example in a manner similar to Examples 1 to 20 and Comparative Examples 1 to 8. The master alloys were processed by a water atomization method to obtain amorphous soft magnetic powder having an average grain diameter of 10 μm. An X-ray diffraction analysis was carried out to evaluate whether to have an amorphous phase. Next, in a manner similar to Examples 72 to 78 and Comparative Examples 20 to 22, the granulated material powder was obtained by carrying out granulation. The coil 8 used in this process has a cross-sectional shape of 2.0 mm×0.6 mm. The coil 8 was formed by wounding edgewise a flat type conductor having an insulating layer of polyamide-imide formed on a surface thereof with a thickness of 20 μm. The number of turns was 3.5. The aforementioned material powder was filled in a cavity of a die in such a state that the coil 8 was placed within the die. Forming was conducted under a pressure of around 800 MPa and the same L (=0.55 μH). Next, the compact was withdrawn from the die, and a hardening process of the binder was performed. Forming was conducted on a portion that extended outside of the compact of the coil terminal, thereby providing a terminal 9 for surface mounting. Then heat treatment was performed at a temperature of 450° C. for 15 minutes for Example 79. As for Example 80, heat treatment was performed at a temperature of 400° C. for 15 minutes. In addition, as a conventional material, powder having the composition same as that of Comparative Example 22 was manufactured by molding under the same condition as the above-described condition. The implementation efficiency was measured for the inductor 10 which was thus obtained.

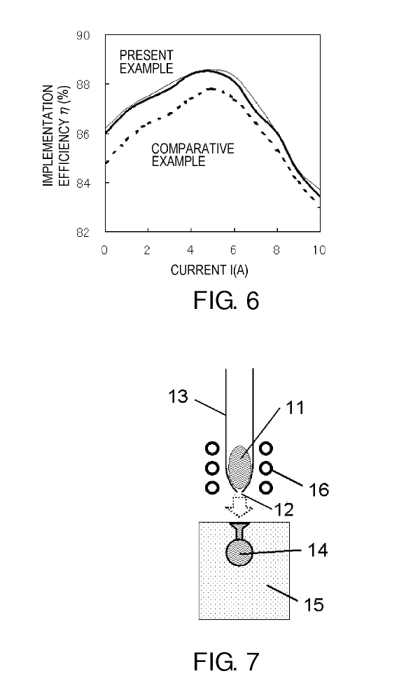

FIG. 6 shows an implementation efficiency of the inductor having a composition of Examples 79 and 80 and Comparative Example 23. In FIG. 6, the inductor having the composition of Example 79 is shown by a heavy solid line, the inductor having a composition of Example 80 is shown by a thin solid line, and the inductor having a composition of Comparative Example 23 is shown by a broken line (comparative example). In the example of the present embodiment, the forming pressure was adjusted so that L=0.6 μH for the inductors of this example and the comparative example. As is apparent from FIG. 6, the inductor of the present example exhibited more excellent characteristics than the comparative example. It is to be understood from this result that the present invention contributes to improvements in the characteristic and miniaturization of size of the inductor which is an important electronic part. Especially the improvements in the implementation efficiency greatly contributes to energy-saving and is very useful in terms of attentions to the environmental problems.

### Example 81, Comparative Example 24, 25

Materials of Fe, Si, B, Fe₃P, Nb and CR were respectively weighed so as to provide samples. A list of compositions of Example 81 of the present invention and Comparative Examples 24, 25 is shown in Table 6. Master alloys were manufactured in the manner similar to Examples 1 to 20 of the present invention and Comparative Examples 1 to 8. The master alloys were processed by a mold casting method so as to produce molded disk-shaped plates. The molded disk-shaped plates have a diameter of 8 mm and a thickness of 0.5 mm. As shown in FIG. 7, the master alloy 11 having the predetermined composition is put into a quartz nozzle 13 having a small hole 12 at its end. The quartz nozzle 13 is placed right above a copper mold 15 having a mold 14 which has a disk-like shape having a diameter of 8 mm and a thickness of 0.5 mm as a molding space. Heat melting is carried out by a high-frequency generator coil 16, and then the molten master alloy 11 in the quartz nozzle 13 is spouted from the small hole 12 in the quartz nozzle 13 by a pressurized argon gas and poured into the mold 14 having a disk-like shape of the copper mold 15. The metal is left in that state and solidified. An X-ray diffraction analysis was carried out to judge the phase of the surface of each plate member. Those plate members which have been judged as having amorphous phase were subjected to a grinding process thereby forming the plate members into a toroidal shape by forming a hole of about 5 mm at a center of each plate member. Next, heat treatment was carried out for 60 minutes under 450° C. After wires have been wound thereon, measurement was carried out for the maximum magnetic permeability μm by using a current BH analyzer. Table 6 shows the X-ray diffraction analysis and the maximum magnetic permeability μm of each Comparative Examples 24 and 25.

TABLE 6

| | | Disk-shaped plate | |
|---|---|---|---|
| | Alloy Composition [at %] | member | Maximum permeability |
| Example 81 | {Fe_{0.76}(Si_{0.3}B_{0.5}P_{0.2})_{0.24}}₉₈Nb₁Cr₁ | amorphous phase | 320000 |
| Comparative | Fe—3Si—8Cr (weight %) | — | 8500 |
| Example 24 | | | |
| Comparative | Fe₇₈Si₉B₁₃ | crystal phase | — |
| Example 25 | | | |

As shown in Table 6, the soft magnetic amorphous alloy of Example 81 has an amorphous single phase and has a high maximum magnetic permeability μm as compared to a Comparative Example 24. In Comparative Example 25 which is a conventional amorphous composition including the Fe, Si, and B elements, a capability of forming an amorphous phase is low and a disk-shaped plate member of amorphous single phase could not be obtained.

As thus far been described with reference to the embodiments, by selecting a composition of the soft magnetic amorphous alloy of the present invention, alloys having an efficient capability of forming an amorphous phase and efficient soft magnetic property can be obtained at low cost. Moreover, amorphous powder of the soft magnetic amorphous alloy of the present invention as well as the efficient magnetic members such as the dust core, the amorphous ribbon, the amorphous piece, the amorphous bulk members using the powder can be obtained. The present invention is not limited to the aforementioned embodiments and Examples. It is understood that the changes and modifications should fall within the technical scope of the present invention. It would be apparent the various modifications which will be made by those skilled in the art may should fall within the present invention.

1. A soft magnetic amorphous alloy represented by a composition formula {Feₐ(SiₓB_{y}P_{z})₁₋ₐ}_{100-b}L_{b}, wherein
L is one or more element selected from Al, Cr, Zr, Nb, Mo, Hf, Ta and W, and
the following conditions are met: 0.7≦a≦0.82; 0≦b≦5 atom %; 0.05≦x≦0.6; 0.1≦y≦0.85; 0.05≦z≦0.7; and x+y+z=1.

2. The soft magnetic amorphous alloy as claimed in claim 1, wherein 50 atomic % or less of Fe element is replaced by one or more elements selected from Co and Ni.

3. The soft magnetic amorphous alloy as claimed in claim 1, wherein the soft magnetic amorphous alloy meets the condition of 0.5≦b≦5 atomic %, and an amount of Cr is 0.3 atomic % or higher.

4. The soft magnetic amorphous alloy as claimed in claim 1, wherein L is one or more elements selected from Al, Cr, Nb and Mo, the soft magnetic amorphous alloy meets the condition of 1≦=b≦5 atomic %, and an amount of Cr is 0.5 atomic % or higher.

5. The soft magnetic amorphous alloy as claimed in claim 1, wherein, when an amount of P element contained in the soft magnetic amorphous alloy is represented by U=z(1-a)(100-b), the soft magnetic amorphous alloy meets the condition of 0.45≦U/b≦30.

6. The soft magnetic amorphous alloy as claimed in claim 5, wherein L element contains at least Cr element, when an amount of Cr element contained in the soft magnetic amorphous alloy is represented by b_{Cr}, the soft magnetic amorphous alloy meets the condition of 0.9≦U/b_{Cr}≦30.

7. The soft magnetic amorphous alloy as claimed in claim 5, wherein L element contains at least Nb element, when an amount of Nb element contained in the soft magnetic amorphous alloy is represented by b_{Nb}, the soft magnetic amorphous alloy meets the condition of 0.45≦U/b_{Nb}≦24.

8. The soft magnetic amorphous alloy as claimed in claim 1, wherein the soft magnetic amorphous alloy has a saturation magnetic flux density of from 1.2 T to 1.8 T.

9. The soft magnetic amorphous alloy as claimed in claim 1, wherein its supercooled liquid region represented by ΔTx=Tx−Tg (Tx: temperature at which crystallization starts, Tg: glass transition temperature) is in a range from 20° C. to 80° C.

10. An amorphous powder made of the soft magnetic amorphous alloy as claimed in claim 1, wherein the amorphous powder has an average diameter of from 1 μm to 150 μm.

11. A dust core formed by molding a mixture containing the amorphous powder claimed in claim 10 and a binder.

12. An inductor made by arranging a dust core near a coil, the dust core being formed by molding a mixture containing the amorphous powder as claimed in claim 10 and a binder.

13. An amorphous material consisting of the soft magnetic amorphous alloy claimed in claim 1, wherein the amorphous material is formed as an amorphous ribbon or an amorphous piece and has a coercive force of from 0.1 A/m to 2.5 A/m.

14. An amorphous material consisting of the soft magnetic amorphous alloy claimed in claim 1, wherein the amorphous material is formed as an amorphous ribbon or an amorphous piece and has a thickness of from 0.01 mm to 1.0 mm.

15. The amorphous alloy material as claimed in claim 14, wherein a thickness of the amorphous alloy material is in a range from 0.1 mm to 1.0 mm.

16. A magnetic core made of the amorphous alloy material claimed in claim 13, wherein the magnetic core is a wound magnetic core or a multilayer magnetic core.

17. An amorphous bulk member made of soft magnetic amorphous alloy claimed in claim 1, wherein a thickness of the amorphous bulk member is in a range from 0.5 mm to 3.0 mm.

18. The soft magnetic amorphous alloy as claimed in claim 2, wherein the soft magnetic amorphous alloy meets the condition of 0.5≦b≦5 atomic %, and an amount of Cr is 0.3 atomic % or higher.

19. The soft magnetic amorphous alloy as claimed in claim 2, wherein L is one or more elements selected from Al, Cr, Nb and Mo, the soft magnetic amorphous alloy meets the condition of 1≦=b≦5 atomic %, and an amount of Cr is 0.5 atomic % or higher.
